(19) United States
(12) Patent Application Publication
(10) Pub. No.: US 2011/0036761 A1
(43) Pub. Date: Feb. 17, 2011

(54) AUTOMATIC OZONE WATER OUTPUT DEVICE

(75) Inventors: Shih-Chang CHEN, Hsinchu County (TW); Chih-Chung CHENG, Hsinchu County (TW)

Correspondence Address: ROSENBERG, KLEIN & LEE, 3458 ELLICOTT CENTER DRIVE-SUITE 101, ELLICOTT CITY, MD, 21043, US

(73) Assignee: CASHIDO CORPORATION, HSINCHU COUNTY (TW)

(21) Appl. No.: 12/852,691

(22) Filed: Aug. 9, 2010

(30) Foreign Application Priority Data
Aug. 14, 2009 (TW) 98214965

(51) Int. Cl. C02F 1/78

(52) U.S. Cl. 210/101

(57) ABSTRACT

An automatic ozone water output device includes a faucet unit, at least one water inlet pipe, and an ozone generator. The faucet unit will automatically detect the presence of a user to output water. The water inlet pipe having a Venturi section connects the faucet unit and a water source. An ozone generating device having a pressure-sensitive activator is kept in a concealed space or a sheltered location, such as in the area under a basin or a sink. When water flows through the Venturi pipe, a negative pressure is developed and sensed by the pressure-sensitive activator. In response, the pressure-sensitive activator activates the ozone generator, thereby causing the mixing of ozone with the discharged water.

### BACKGROUND OF THE INVENTION

1. Field of the Invention

The present invention relates to an automatic ozone water output device with at least one water input tube.

2. Description of Related Art

Ozone (O₃) is a highly active and unstable gas, and is easily combinable with positive ions to generate un-harmful chemical compounds. Because objects or microorganisms that are harmful for people health usually possess positive ions, ozone can effectively oxidize them on contact to neutralize the harmful objects. Moreover, the solubility of ozone is remarkably high. Thus, ozone has been a popular cleaning agent for decades. Currently, numerous cleaning equipments are taking advantage of the cleaning power of ozone; such devices include washing machines, refrigerators, air-conditioners, and air-cleaning machines, etc.

The principle for generating ozone is simple, as ozone in the nature environment is generated by the discharging of lightning in the atmosphere. Industrially, one method of generating ozone comprises guiding air into a chamber between two electric poles through a high voltage discharging process. The oxygen molecules that pass through the electric poles are excited and thus spilt into individual oxygen atoms. The oxygen atoms are then combined with surrounding oxygen molecules to form ozone. Because the principle of the ozone generators is simple, ozone generators have been well developed and applied to a wide range of sanitation equipments.

Since ozone possesses excellent disinfecting and deodorizing properties, it is naturally logical to install ozone generators in public environments; the phagocytic property of ozone makes it a beneficial choice for use in the public water supply system to improve public hygiene, particularly in the public water faucet equipments.

However, the development emphasis of public faucet equipments has been placed on the conservation of power and water, or merely the appearance of the faucet unit; the ability to provide additional sanitary functions has traditionally not been a concern. Also, an externally mounted ozone generator unit, such as the one disclosed in U.S. Patent Publication No.: 2006/0266683, would not only hinder the esthetic appearance of the public facilities, the exposing unit would more likely suffer damage from accidental/intentional abuse from the general public.

Therefore, it is desirable to provide a simple and durable ozone water generating machine that can be easily and concealedly installed in various public environments to improve the quality of water supply.

### SUMMARY OF THE INVENTION

The objective of the present invention is to provide an automatic ozone water output device that automatically adds ozone to water in public places. Moreover, the automatic ozone water output device is durable and requires low maintenance, thus making this device ideal for improving public hygiene.

Another objective of the present invention is to provide an automatic ozone water output device whose structure is simple, installation process is easy, is not easily damaged, has a long life expectancy, and has low maintenance cost.

In order to achieve the aforementioned objectives, according to an embodiment of the present invention, an automatic ozone water output device is provided. The automatic ozone water output device includes a faucet unit, at least one water inlet pipe comprising a Venturi section, and an ozone generating device in connection with the water inlet pipe through the venture section in a concealed space or other sheltered locations, such as the area under the basin or sink area of the faucet. The faucet unit can be a conventional or an automatic unit capable of detecting the presence of a user. The water inlet pipe is used for providing the faucet unit water from a water source. A Venturi pipe is disposed on the water inlet pipe and is in connection with the ozone generator. The Venturi pipe comprises two end portions having wider diameters and a narrower flow channel in the center portion. An ozone manifold is located on the narrower central portion of the venture pipe. The two wider ends of the venture pipe are communicatively disposed on the water inlet pipe, while the ozone manifold is connected to the ozone generator via an ozone dispensing pipe. Moreover, the ozone generator comprises a pressure-sensitive activator. As water flows through the Venturi section of the water inlet pipe, a negative pressure is developed at the narrower center section. The pressure-sensitive activator senses the low pressure at the venture pipe and activates the ozone generator in response. The low pressure developed at the ozone manifold forces the generated ozone into the water outlet pipe to mix with the discharging water. The ozone water is thus outputted from the faucet unit to a user.

In order to further the understanding regarding the present invention, the following embodiments are provided along with illustrations to facilitate the disclosure of the present invention.

### BRIEF DESCRIPTION OF THE DRAWINGS

FIG. 1 shows a schematic diagram of the automatic ozone water output device, according to an embodiment of the present invention;

FIG. 2 shows a schematic diagram of the operation principle of the ozone generating device according to an embodiment of the present invention; and

FIG. 3 shows a schematic diagram of the operation principle of the Venturi pipe according to an embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

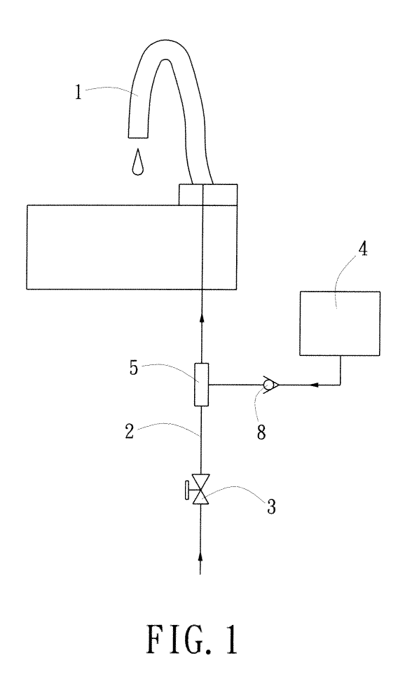

Reference is made to FIG. 1, which shows a schematic diagram of the automatic ozone water output device. The automatic ozone water output device comprises a faucet unit 1, at least one water inlet pipe 2, and an ozone generator 4. The faucet unit 1 can be a conventional or an automatic unit capable of detecting the presence of a user. In particular, an automatic faucet unit may sense the presence of a user by using infrared rays, or static capacitor etc. The water inlet pipe 2 may be a conventional water pipe for connecting a water source with the sensor faucet 1. An electromagnetic valve 3 is disposed on the water inlet pipe 2 in conjunction with an automatic faucet unit. When the automatic faucet 1 detects the presence of a user, the electromagnet valve 3 is turned on to allow water flow through the water inlet pipe 2. Furthermore, a Venturi pipe 5 is installed on the water inlet pipe 2 to form a Venturi section.

The automatic ozone output device further comprises an ozone generator 4 in a concealed space or other sheltered locations, such as the area under a basin and a sink. By using the negative pressure generated under the water flows through the Venturi section of the water inlet pipe 2, the pressure-sensitive activator 6 will activate the ozone generator 4 to start generating ozone. Moreover, as water flows through the outlet pipe, the low pressure developed at the ozone manifold forces the generated ozone into the water outlet pipe through the ozone dispensing pipe and mix with the discharging water.

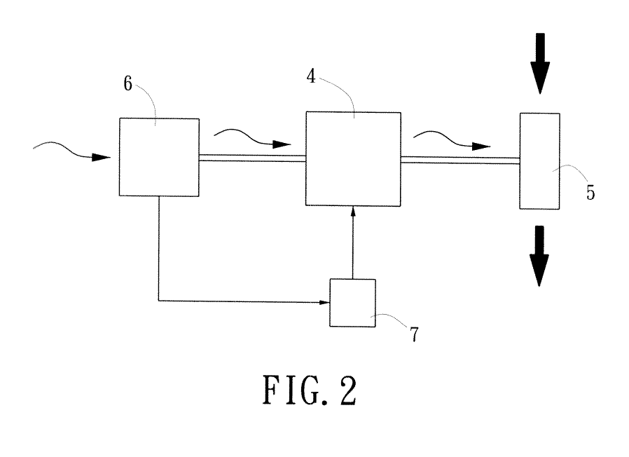

Reference is made to FIG. 2. The ozone generating device 4 has a pressure-sensitive activator 6. The pressure-sensitive activator 6 controls a power unit 7. When water flows through the Venturi pipe 5, a negative pressure is generated, thus triggering the pressure-sensitive activator 6. The power unit 7 is thus activated by the pressure-sensitive activator, thereby turning on the ozone generator 4 to generate ozone. The ozone is absorbed at the negative pressure location of the Venturi pipe 5 to mix ozone with water to form ozone water.

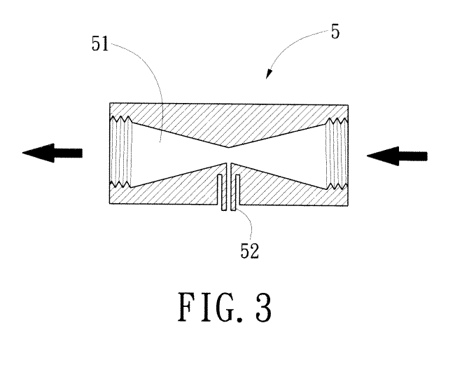

Reference is made to FIG. 3. The Venturi pipe 5 has a flow channel 51 that both ends are wide and the middle portion is narrow, and a manifold 52 extending from the narrow middle portion. According to the Venturi principle, when water flows through the reactor faucet 1, negative pressure is formed at the narrow middle portion of the flow channel 51. The negative pressure makes the manifold 52 generate an absorbing force to absorb ozone generated from the ozone generating device 4 into the flow channel The ozone is mixed with water, and then ozone water is outputted from the sensor faucet 1. There is an reverse-stopping valve 8 (as shown in FIG. 1) at the manifold 52 that is connected with the ozone generating pipe 4 to prevent water from flowing back to the ozone generating device 4 to damage the ozone generating device 4 when the faucet is turned off.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. An automatic ozone water output device having an automatic faucet and at least one water inlet pipe, comprising:
an ozone generator installed in the space under the automatic faucet basin and sink in a sheltered location;
a Venturi pipe having a flow channel and a manifold extended from the narrow middle portion, wherein the flow channel is installed on the water inlet pipe, the manifold is connected with the ozone generator, whereby when water flows through the flow channel, a negative pressure is formed at the manifold to activate the ozone generator, thereby facilitating the mixing of ozone into the water.

2. The automatic ozone water output device according to claim 1, wherein the ozone generating device comprises a negative pressure sensor, wherein the negative pressure sensor activates the ozone generator when a negative pressure is sensed in the manifold of the Venturi pipe.

3. The automatic ozone water output device according to claim 1, further including a reverse-stopping valve at the manifold in connection with the ozone generator for preventing water from flowing back to the ozone generator and causing damage thereto when the faucet is turned off.
